(19) United States
(12) Patent Application Publication
(10) Pub. No.: US 2022/0003021 A1
(43) Pub. Date: Jan. 6, 2022

(54) ANTI-BURGLAR BAR FOR SHUTTERS OR ROLLER SHUTTERS

(71) Applicant: SIPAR S.R.L., Pian Camuno (BS) (IT)

(72) Inventor: Paolo ANDREOLI, Pian Camuno (BS) (IT)

(21) Appl. No.: 17/291,260

(22) PCT Filed: Oct. 31, 2019
(86) PCT No.: PCT/IB2019/059336

§ 371 Date: May 4, 2021

(30) Foreign Application Priority Data
Nov. 5, 2018 (IT) 102018000010031

(51) Int. Cl. E05B 65/00; E05B 47/00; E05B 63/00; E06B 9/15

(52) U.S. Cl. CPC E05B 65/0021; E05B 47/0012; E05B 63/0069; E05B 2047/0067; E05B 2047/0017; E05B 2047/002; E06B 9/15

(57) ABSTRACT

An anti-burglar bar (1) for rolling shutters (2) or rolling gates, which are defined by a plurality of horizontal slats (3) associated with a winding roller and are slidable in a first and a second vertical guides (4,5) opposite to one another, comprises electromechanical control means (7) of a first and a second blocking elements (8) and (9), arranged slidingly in a body (11), which engage respectively in a first and a second retention blocks (10) associated with said first and second guides respectively, a first and a second feelers (12) being provided which engage respectively with a first and a second position sensors (13) for transmitting an electric signal, said electric signal activating said electromechanical control means (7) only when said first and second feelers (12) are simultaneously aligned with said first and second position sensors (13) respectively.

### BACKGROUND OF THE INVENTION

The present invention relates to an anti-burglar bar for rolling shutters or rolling gates.

As is known, currently there are various types of rolling shutters or rolling gates available on the market, normally defined by a plurality of slats horizontally associated to each other so that they can be rolled about a winding roller that can be activated in rotation either manually or by means of a gear motor.

The current rolling shutters or rolling gates have two vertical guides, inside of which the slats are able to slide to enable the raising or the lowering of the rolling shutter or rolling gate via the winding roller.

In the current rolling shutters or rolling gates, the burglary or the tampering thereof is made easier by the fact that by applying a force, from the bottom upwards on the last slat, also defined as laths or floor boards, it is possible to lift the rolling shutter or the rolling gate, without having to applying too much force, in order to break into the premises, which should be protected therefrom.

This problem is even more severe for some types of shutters that involve the mutual association of the slats, implemented in order to allow a preset spacing between one slat and the other, so as to give the shutter the function of total darkening as well as providing a shield against the sun and/or against the wind, thanks to the partial spacing of the slats.

The spacing of the slats, in fact, as is easily understandable, greatly facilitates the possibility of burglary or tampering of the shutter since, by lifting the shutter, the force exerted from the bottom upwards on the latter, allows the slats to move closer to one another without offering any resistance to counter this action.

### SUMMARY OF THE INVENTION

The aim of the present invention is to provide an anti-burglar bar for rolling shutters or rolling gates that will overcome the drawbacks of the prior art referred to above.

In the scope of the above aim, an object of the present invention is to provide an anti-burglar bar for rolling shutters or rolling gates that is both easy to install also on pre-existing rolling shutters or rolling gates equipped with, or without, a motorised winding roller.

Yet another object of the present invention is to provide an anti-burglar bar for rolling shutters or rolling gates that constitutes a completely independent electrically powered unit that can be associated with laths of any structure, shape and size.

Yet a further object of the present invention is to provide an anti-burglar bar for rolling shutters or rolling gates that can also be sold as a kit to be applied to rolling shutters or rolling gates of any type and size.

Yet a further object of the present invention is to provide an anti-burglar bar for rolling shutters or rolling gates that generates the blocking of the latter on two symmetrically opposite areas of the sliding vertical guides.

Not the least important object of the present invention is to provide an anti-burglar bar for rolling shutters or rolling gates that activates only when arranged in a preset position and that can interact during operation with the gear motor of the winding roller and that is easy to replace or carry out maintenance operations thereon.

This aim and these and other objects still, are achieved by an anti-burglar bar 1 for rolling shutters 2 or rolling gates which are defined by a plurality of horizontal slats 3 associated with a winding roller and that are slidable in a first and a second vertical guides 4, 5 opposite to one another, said bar being characterised in that it comprises electromechanical control means 7 of a first and a second blocking elements 8 and 9 arranged slidingly in a body 11 along an axis orthogonal to said first and second guides, which slidingly engage in a first and a second retention blocks 10, respectively, associated with said first and second guides, respectively, in a position in front of said body 11, a first and a second feeler 12 being also provided, engaging with a first and a second position sensors 13, respectively, for transmitting an electric signal, said electric signal activating said electromechanical control means only when said first and second feelers 12 are simultaneously aligned with said first and second position sensors 13, respectively, and only when said bar is perfectly aligned with said first and second retention blocks 10.

The dependent claims specify more fully further characteristics of the anti-burglar bar for rolling shutters or rolling gates according to the present invention.

In particular the first and second feelers are each movable in opposition and by the action of a first and a second springs.

The springs are designed to transmit an electric signal.

The first and second springs each have a stem that electrically engages with the control means.

The control means comprise a first and a second rods each having a first and a second shaped sides.

The first and second shaped sides engage with a dragging-wheel having two pins.

The dragging-wheel is set in rotation by a gear motor.

The first and second rods move simultaneously in a direction opposite to one another between a forward stroke and a return stroke only when the dragging-wheel is set in rotation by the gear motor.

The first and second rods, the gear motor and the dragging-wheel are contained in a separate housing, that can be internally associated with the bar along the longitudinal extension of the same.

The first and second rods are removably associated with the first and second blocking elements so as to vary their length with respect to the positioning of the housing along the bar.

The anti-burglar bar comprises an emergency device.

The emergency device comprises at least a button having a cam engaging with the gear motor and the dragging-wheel so as to cause the latter to engage with or disengage from the gear motor.

The anti-burglar bar comprises means for controlling the positioning of said first and second blocking elements.

The control means comprise at least a pair of microswitches housed in said separate housing.

The anti-burglar bar is housed in a casing formed by a first profile and by a second profile having, respectively, at least a first edge and a second edge that are snap-couplable at the front.

The first and second edges are fastened to one another by at least an immovable screw when said horizontal slats are in a closing position.

The first and second blocking elements each comprise at least a first position indicator interacting with at least a second position indicator.

The second position indicator is present in the first and second retention blocks, respectively, to detect the correct insertion of said first and second blocking elements therein.

### BRIEF DESCRIPTION OF THE DRAWINGS

The above characteristics and the advantages of the present invention will emerge more clearly from the following indicative and non-limiting description, of preferred yet not exclusive embodiments of an anti-burglar bar for rolling shutters or rolling gates illustrated in the following drawings, wherein:

FIG. 1 is a partial perspective front elevation view of a rolling shutter with the anti-burglar bar according to the present invention;

FIG. 2 is a cutaway front elevation view of the anti-burglar bar for rolling shutters or rolling gates according to the present invention;

FIG. 3 is a perspective sectioned view of the electromechanical control means according to the present invention;

FIG. 4 is a view of the dragging-wheel having two pins according to the present invention;

FIG. 5 is a sectioned perspective front elevation view of the connection of the second feeler of the second block with the second blocking element and the second sensor according to the present invention;

FIG. 6 is a perspective view of the coupling of the dragging-wheel with the counter-wheel according to the present invention;

FIG. 7 is a sectioned perspective view of the coupling of the dragging-wheel with the counter-wheel according to the present invention;

FIG. 8 is a perspective view of the buttons, the rotation of which determines the spacing of the dragging-wheel from the gear motor according to the present invention;

FIG. 9 shows, in cross-section, the casing formed by a first profile and by a second profile having, respectively, at least a first edge and a second edge snap-couplable at the front, according to the present invention;

FIG. 10 shows in section the first edge and the second edge fixed to one another by at least an immovable screw; and

FIG. 11 is a perspective view in section of an alternative construction of the coupling of the first feeler present on the bar with the first sensor present on the first block and the first blocking element with the first block.

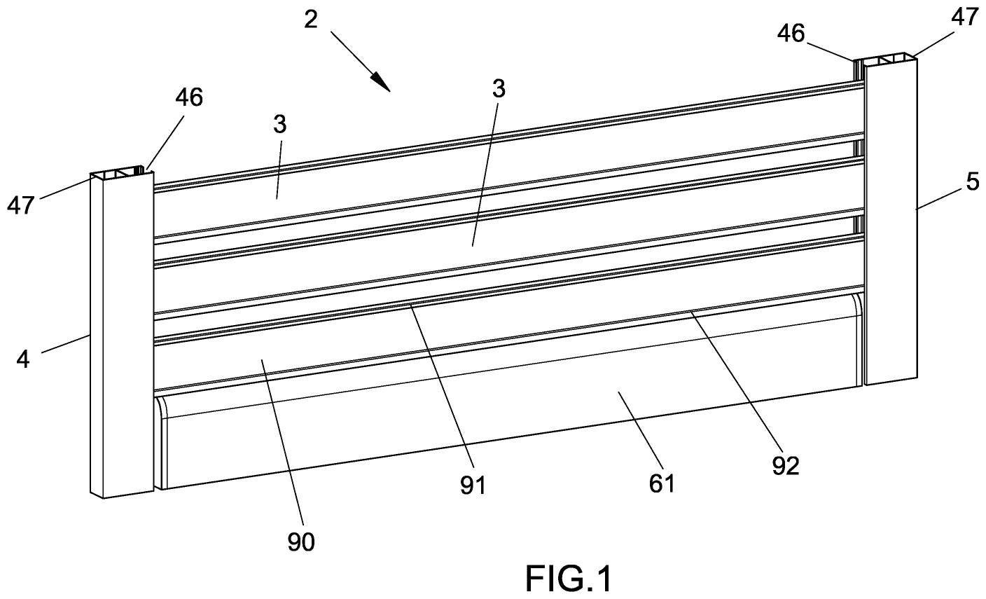

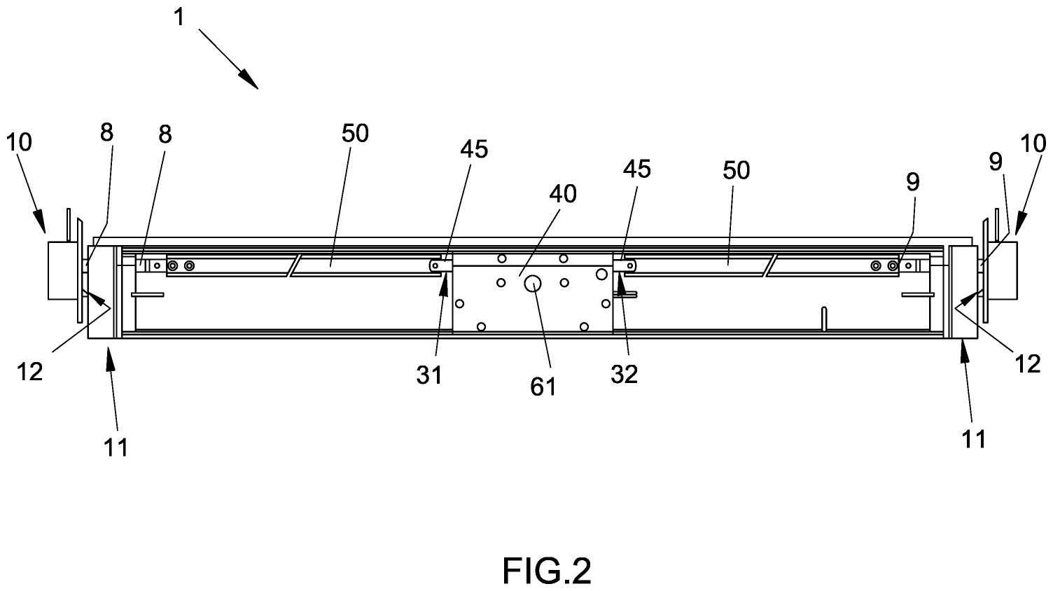

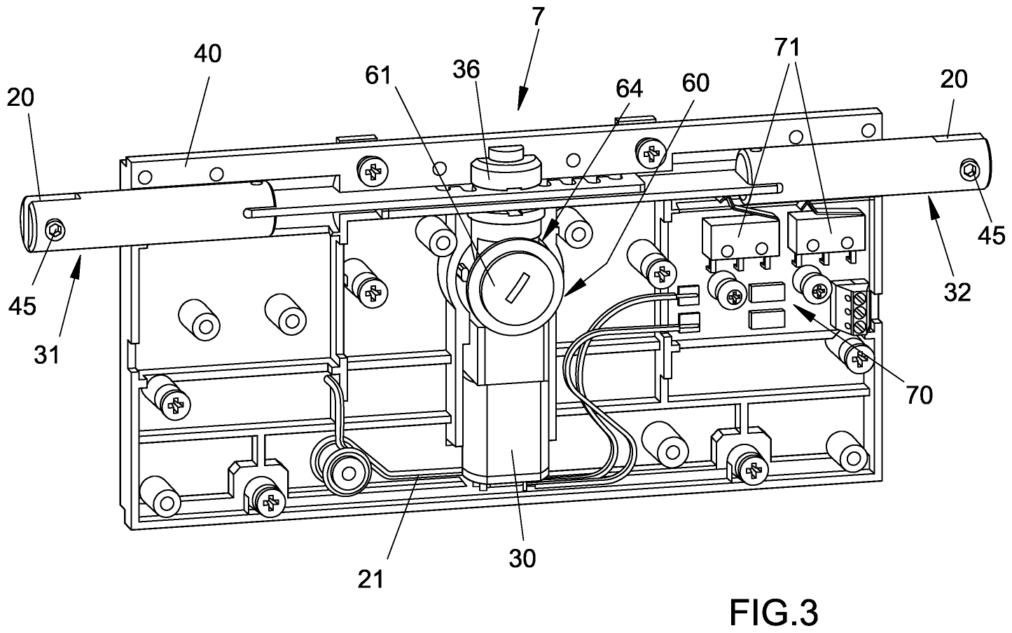

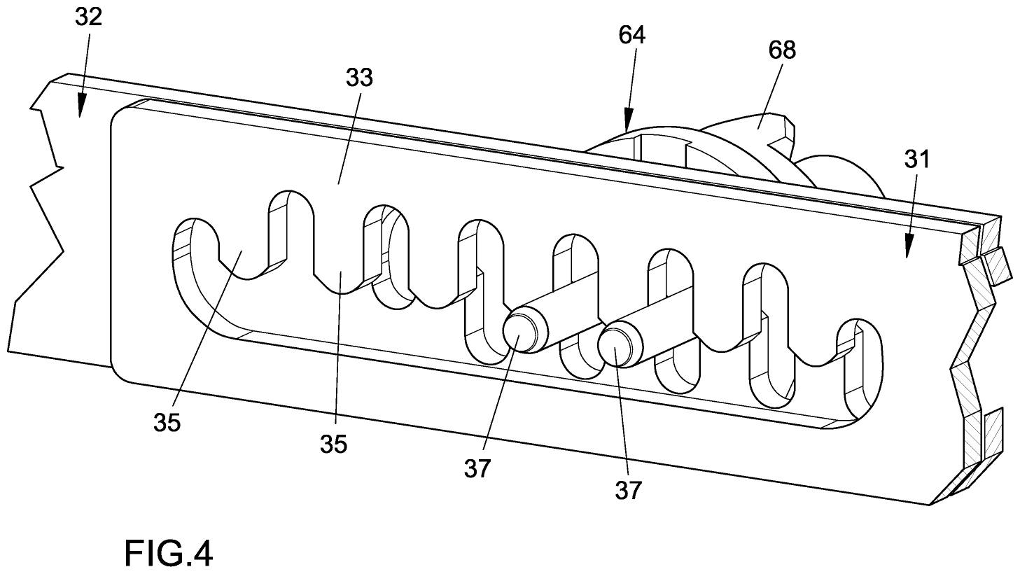

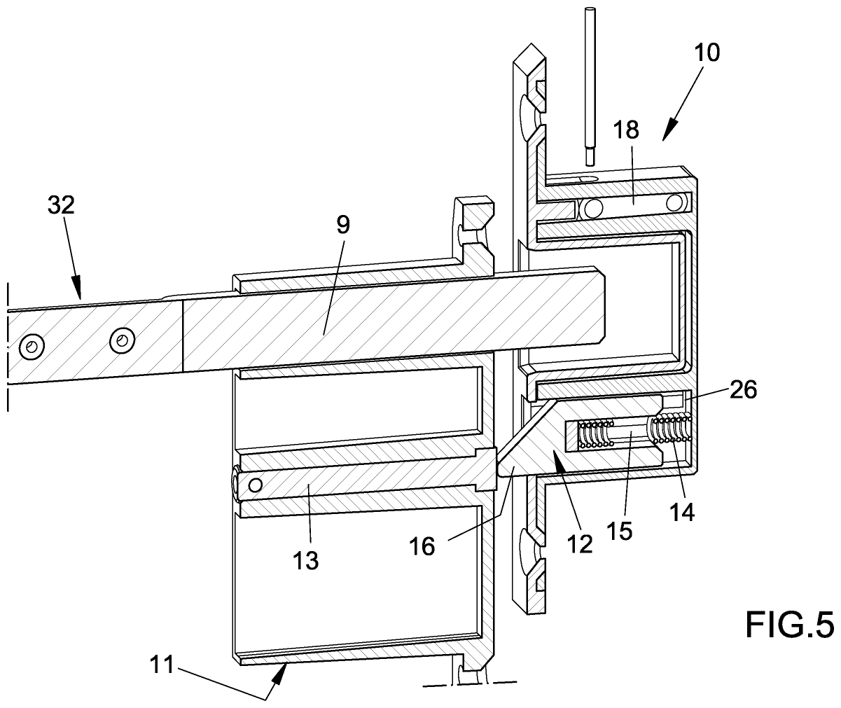

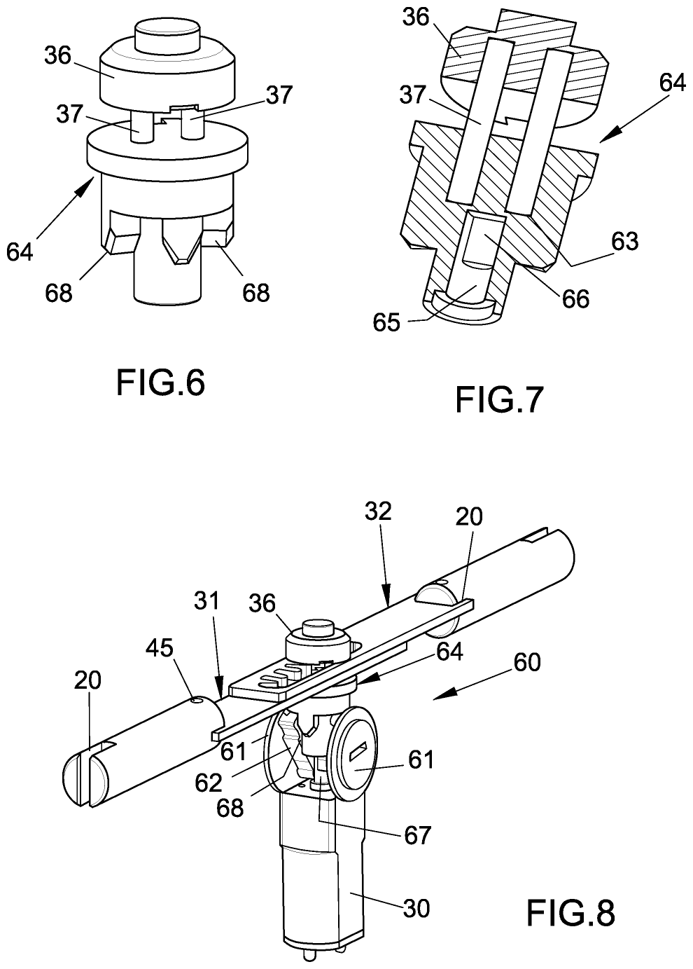

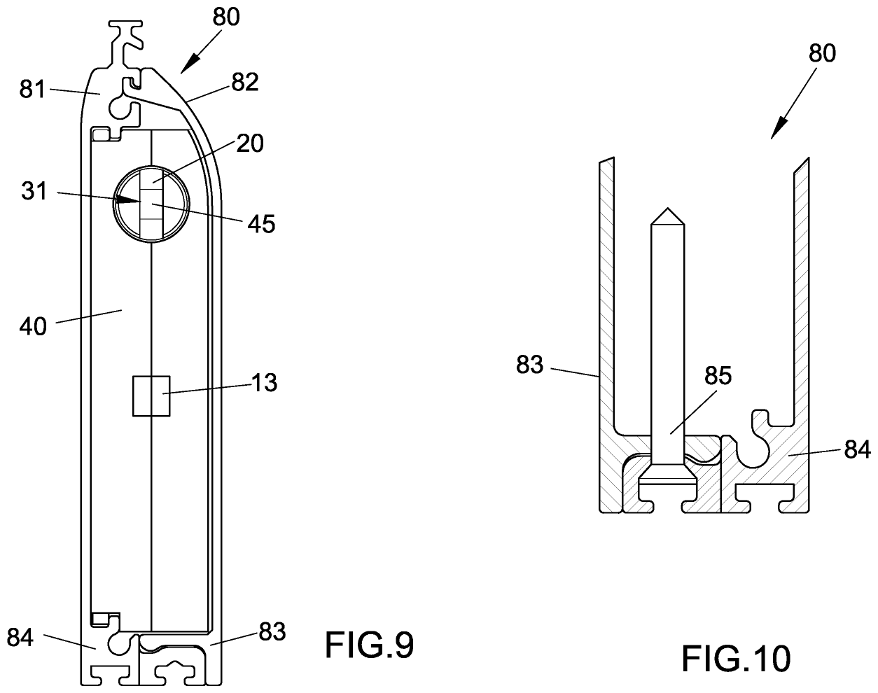

### DESCRIPTION OF THE PREFERRED EMBODIMENTS

With particular reference to the Figures described above, the anti-burglar bar for rolling shutters 2 or rolling gates, according to the present invention, is generically designated with the reference number 1.

In particular, the anti-burglar bar can be applied to any type of rolling shutters 2 or rolling gates which are defined by a plurality of horizontal slats 3 associated with a winding roller, not shown, and which are slidable in a first and a second vertical guides 4, 5 opposite to one another.

The bar comprises electromechanical control means, generically designated with 7, of a first blocking element 8 and a second blocking element 9 of the bar with respect to the guides 4 and 5.

The blocking elements 8 and 9, arranged in a body 11, respectively engage in a first and a second retention blocks 10 which are associated with the first and second guides 4 and 5, respectively.

In the following, for simplicity, only the different elements of the control means and of the blocks which are positioned on the side of the first guide 4 or on the side of the second guide 5 will be described and numbered according to the Figures.

The control means 7 also comprise a first and a second feeler 12, engaging with a first and a second position sensors 13, respectively.

In the preferred solution, the first and second feelers are in the first and second blocks and the first and second sensors are associated with the bar.

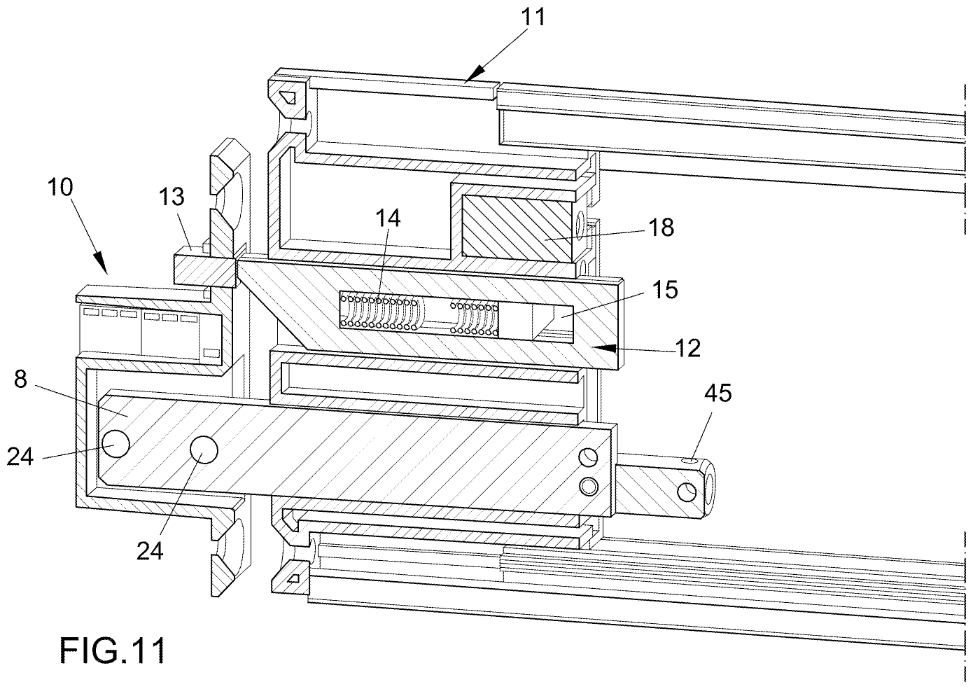

In an alternative construction, as shown in FIG. 11, the first and second feelers are associated with the bar and the first and second sensors are present in the first and second retention blocks 10.

Advantageously, the electromechanical control means 7 are activated only when the first and the second feelers 12 simultaneously engage with the first and second position sensors 13 to transmit an electric signal or pulse to the control means.

This solution enables to activate the control means 7 only and exclusively when the bar 1 is perfectly aligned with the two opposite blocks 10 and therefore in a preset closing position which, normally, is the one defined by the end stroke resting plane of the rolling shutter or rolling gate.

The first and second guides 4 and 5 each have a first and a second sliding seat 46 for the slats 3 and for the bar 1 and a first and a second housing chamber 47 for the first and second retention blocks 10.

In a preferred solution, the chambers 47 are located beside the first and second sliding seats 46.

More precisely, the first and second feelers 12 are each movable in opposition and by the action of a first and a second springs 14 housed, respectively, in an appropriate recess 15 present in each feeler.

Each spring 14 has, as well as an elastically controlled shifting function for each feeler 12, also the function of transmitting the electric signal to the first and second position sensors 13 and therefore to the control means 7 for their activation.

In fact, the first and second springs 14 each have an end electrically connected with the head 16 of each feeler so as to transmit, through mechanical contact, the electric signal to the corresponding sensor 13 and, on the other end, a stem 26 electrically connected to control means via a first and a second terminal blocks 18. The electrical transmission therefore takes place always through the static parts of the bar, which are the first and second blocks.

The electrical connection is obtained through electric wires which connect with the gear motor 30 driving the first and second blocking elements 8 and 9.

Advantageously, the control means comprise a first and a second rods both designated, as a whole, with 31 and 32 each having a first and a second shaped sides 33 which are opposite to one another and formed by a plurality of teeth 35.

The teeth 35 engage with two pins 37 of a dragging-wheel 64 and a counter-wheel 36 set in rotation by the gear motor 30.

In order to avoid the extraction of the two blocking elements 8 and 9 from the respective blocks, advantageously, the first and second rods 31 and 32 can move simultaneously in a direction opposite to one another in a forward stroke and a return stroke only if the dragging-wheel 64 is set in rotation by the gear motor.

On the contrary, the two pins 37, being unaligned with one another, prevent the movement of the rods 31 and 32 if subjected to a movement force other than that of the gear motor, such as for example an attempt to break-in by removing the blocking elements from the respective blocks.

The first and the second rods, together with the gear motor 30 and the dragging-wheel 64 and the counter-wheel 36, are opportunely contained in a separate housing 40, that can be internally associated with the bar 1 along its entire longitudinal development.

The first and second rods are removably associated with the first and the second blocking elements 8 and 9 via the return bars 50 so as to be able to vary their length with respect to the positioning of the housing 40 inside the bar 1.

In this manner it is possible to move the control means to any useful position inside the bar depending on the length of the bar that it is desired to obtain by means of its cutting.

This solution enables the bar to be cut to the desired size according to the length of the slats 3 of the rolling shutter with which it must be associated.

In more detail, if the bar 1 has to be shortened, for example on the right-hand side, to bring it to size with the slats of the rolling shutter, it is sufficient to move, only if necessary, the housing 40 of the control means to the left-hand side and cut one or both of the return bars 50 to size.

These return bars are flat and, in a preferred solution, are inserted in cuts 20 of the cylindrical ends of the compensation elements of the rods 31 and 32 so that they can slidingly engage and compensate for any dimensional differences in length by simply tightening the Allen screws, not shown, which engage in the respective threaded holes 45.

In an alternative construction, also the return bars 50 can be cylindrical, fitting in the cylindrical ends of the blocking elements 8 and 9 and of the rods 31 a 32 so that they can slidingly engage and compensate for any dimensional differences.

Advantageously, the anti-burglar bar comprises an emergency device 60 designed to allow the rolling shutter to move even in the case of power failure.

In particular, the emergency device 60 comprises at least a button 61 having a cam 62 engaging with the gear motor 30 and with the dragging-wheel 64 to bring the latter to engage with or disengage from the gear motor.

The button 61 is actuatable, for example, by a screwdriver, only on the inner side of the housing 40 but is present at both the front and the back of the housing 40 since the bar can be installed indifferently on both a rolling shutter with an inner winding roller and on a rolling shutter with an outer winding roller.

The two pins 37 of the counter-wheel 36 are integral inside respective holes 63 present in the dragging-wheel 64 which has, on the opposite side to the pins 37, a cylindrical-shaped coupling seat 65 with its end being semi-cylindrical-shaped with a flat face 66.

In this manner the drive shaft 67, being shaped so as to match the coupling seat 65, engages in rotation with the dragging-wheel 64 when it is engaged with the flat face 66 and freely rotates in the coupling seat 65 when it is spaced from the flat face 66 thanks to the cam 62 upon the rotation of the button 61.

Subsequently to the axial disengagement of the drive shaft 67 from the flat face 66, if the rotation of the button 61 continues, the cam 62 engages with the teeth 68 of the dragging-wheel 64 setting it into rotation and bringing back the first and second blocking elements 8 and 9 which disengage from the respective blocks thus enabling the movement of the rolling shutter.

After the reset of the power-supply, the drive shaft is again pushed by a torsion spring 21 into the seat 65 and engages via the flat face 66 in rotation with the dragging-wheel 64.

The anti-burglar bar further comprises control means 70 controlling the positioning of the first and second blocking elements 8 and 9.

In particular, the control means 70 comprise at least a pair of microswitches, each designated with 71, housed inside the separate housing 40.

The microswitches 71 are spaced from one another so as to precisely indicate the position of the first and second blocking elements 8 and 9.

In more detail, the microswitches 71 indicate the partial or complete insertion of the first and second blocking elements 8 and 9 inside the respective blocks thus guaranteeing the raising of the rolling shutter only upon reaching their total disengagement from the blocks.

The anti-burglar bar, in a preferred solution, is housed in a casing 80 formed by a first and a second profile 81 and 82 having at least a first and a second edge 83 and 84, respectively, frontally snap-couplable.

This solution presents a noteworthy advantage, in that it allows a simple assembly and disassembly of the bar and furthermore allows access thereto at the front for maintenance, repair and/or control operations by bringing it to an optimal working height and significantly reducing the difficulties and working time for the operator.

For safety reasons, obviously, the first and second edges 83 and 84 are fixed to one another by at least an immovable screw 85 when the horizontal slats are in a closed position and the first and second blocking elements 8 and 9 are engaged inside the respective blocks.

In an alternative construction, instead of the microswitches 71, the first and second blocking elements 8 and 9 can each comprise at least a first position indicator 24 that interacts with at least a second position indicator present on each block, to detect the correct insertion of the blocking elements inside the latter.

In particular, as shown in FIG. 11, each blocking element has two position indicators 24, made with magnets, that interact with two position indicators present in each block in order to detect the exact insertion position of the blocking elements therein, and which must correspond to their end of stroke.

In this manner, an inaccurate insertion or anyway an insertion different from the one preset, prevents the activation of the gear motor 30.

Advantageously the anti-burglar bar according to the present invention is equipped with a connection slat 90 having a first side 91 having a shape designed to engage with the slats 3 of the rolling shutter and a second side 92, opposite to the first side, having a shape designed to engage with the bar itself so that the bar can be applied to any type of slat of any type of rolling shutter.

The operation of the bar 1 is as simple as it is robust and ingenious.

For example, in the case of a motorised winding roller, the descent of the rolling shutter is controlled along the guides 4 and 5.

When both of the feelers 12 mechanically and electrically engage with the sensors 13 they are reinserted into their seat countering the action of the spring 14.

The electric signal transmitted simultaneously by both of the feelers 12 activates the gear motor 30 which sets the two pins 37 into rotation, which move the two blocking elements 8 and 9 in opposite directions.

The two blocking elements are inserted inside the respective blocks which, thanks to the microswitches 71 or to the magnets, detect the exact positioning of the blocking elements and stop the gear motor 30.

The blocking elements can only be moved from their closing position by the actuation of the gear motor, which is automatically activated, for example, by controlling the raising of the rolling shutter.

In the case of a power failure, it is possible to rotate the button 61 to disengage the drive shaft of the gear motor from the counter-wheel and open the rolling shutter.

The anti-burglar bar for rolling shutters or rolling gates according to the present invention has numerous advantages.

For example, while the command for activation and deactivation is electromechanical, its resistance to burglaries is predominantly mechanical since the blocking elements cannot be extracted from the respective blocks as they are locked by the teeth of the displacement cam.

Furthermore, the maintenance or replacement of the bar is made extremely easy as it is brought to an optimal working height for the operator simply by raising the rolling shutter to the necessary height.

The anti-burglar bar for rolling shutters or rolling gates as conceived, is susceptible to modifications and variations all falling within the inventive concept; furthermore, the materials can be of any type according to the needs.

1-15. (canceled)

16. An anti-burglar bar (1) for rolling shutters (2) or rolling gates which are defined by a plurality of horizontal slats (3), associated with a winding roller, and are slidable in a first and a second vertical guides (4,5) opposite to one another, said bar being characterized in that it comprises electromechanical control means (7) of a first and a second blocking elements (8) and (9), arranged slidingly in a body (11) along an axis orthogonal to said first and second guides, which slidingly engage respectively in a first and a second retention blocks (10) housed in said first and second guides respectively, in a position in front of said body (11), a first and a second feelers (12) being provided which engage respectively with a first and a second position sensors (13), said first and a second feelers (12) are each movable in opposition and by the action of a first and a second springs (14), said first and second feelers (12) further transmitting an electric signal activating said electromechanical control means (7) only when said first and second feelers (12) are simultaneously aligned with said first and second position sensors (13) respectively, and only when said bar is aligned with said first and second retaining blocks (10) in a closing position defined by the end stroke resting plane of the rolling shutter or rolling gate.

17. The anti-burglar bar according to claim 16, characterized in that said first and second feelers (12) are arranged in said first and second retention blocks (10) and in that said first and second sensors (13) are associated with said bar.

18. The anti-burglar bar according to claim 16, characterized in that said first and second feelers are associated with said bar and said first and second sensors are arranged in said first and second retention blocks (10).

19. The anti-burglar bar according to claim 16, characterized in that said first and a second springs (14) are designed to transmit said electric signal.

20. The anti-burglar bar according to claim 19, characterized in that said first and second springs (14) each have a stem (26) to which said control means are electrically connected.

21. The anti-burglar bar according to claim 16, characterized in that said control means comprise a first and a second rods (31) and (32), each having a first and a second shaped sides (33) engaging with a counter dragging-wheel (64) having two pins (37), said dragging-wheel being set in rotation by a gear motor (30).

22. The anti-burglar bar according to claim 21, characterized in that said first and second rods move simultaneously in a direction opposite to one another in a forward stroke and a return stroke only if said counter-wheel is set in rotation by said gear motor.

23. The anti-burglar bar according to claim 21, characterized in that said first and second rods, said gear motor and said dragging-wheel are contained in a separate housing (40) that can be internally associated with said bar along the longitudinal extension thereof.

24. The anti-burglar bar according to claim 23, characterized in that said first and second rods are removably associated with said first and second blocking elements through return bars (50) so as to vary their length with respect to the positioning of said housing in said bar.

25. The anti-burglar bar according to claim 16, characterized in that it comprises an emergency device (60).

26. The anti-burglar bar according to claim 25 where said control means comprise a first and a second rods (31) and (32), each having a first and a second shaped sides (33) engaging with a counter dragging-wheel (64) having two pins (37), said dragging-wheel being set in rotation by a gear motor (30), characterized in that said emergency device comprises at least a button (61) having a cam (62) engaging with said gear motor (30) and with said dragging wheel (64) so as to cause the latter to engage with or disengage from the gear motor.

27. The anti-burglar bar according to claim 16, characterized in that it comprises control means (70) for controlling the positioning of said first and second blocking elements (8) and (9).

28. The anti-burglar bar according to claim 27, characterized in that said control means comprise at least a pair of microswitches (71) housed into said separate housing (40).

29. The anti-burglar bar according to claim 16, characterized in that it is housed in a casing (80) composed by a first and a second profiles (81) and (82) having at least a first and a second edges (83,84) respectively, which are frontally snap-couplable, said first and second edges being fastened to one another by at least an immovable screw (85) when said horizontal slats are in the closed position.

30. The anti-burglar bar according to claim 16, characterized in that said first and second blocking elements each comprise at least a first position indicator (24) interacting with at least a second position indicator present in said first and second retention blocks, respectively, to detect the correct insertion of said first and second blocking elements therein.

31. The anti-burglar bar according to claim 22, characterized in that said first and second rods, said gear motor and said dragging-wheel are contained in a separate housing (40) that can be internally associated with said bar along the longitudinal extension thereof.

32. The anti-burglar bar according to claim 31, characterized in that said first and second rods are removably associated with said first and second blocking elements through return bars (50) so as to vary their length with respect to the positioning of said housing in said bar.

33. The anti-burglar bar according to claim 25 wherein said first and second rods move simultaneously in a direction opposite to one another in a forward stroke and a return stroke only if said counter-wheel is set in rotation by said gear motor, characterized in that said emergency device comprises at least a button (61) having a cam (62) engaging with said gear motor (30) and with said dragging wheel (64) so as to cause the latter to engage with or disengage from the gear motor.
